(19) United States
(12) Patent Application Publication
(10) Pub. No.: US 2026/0004155 A1
(43) Pub. Date: Jan. 1, 2026

(54) User Profile Sentiment Analysis

(71) Applicant: Dell Products L.P., Round Rock, TX (US)

(72) Inventors: Yevgeni Gehtman, Modi'in (IL); Tomer Shachar, Beer-Sheva (IL); Ophir Buchman, Raanana (IL)

(21) Appl. No.: 18/757,363

(22) Filed: Jun. 27, 2024

(51) Int. Cl. G06N 5/02; G06Q 30/015

(52) U.S. Cl. CPC G06N 5/02; G06Q 30/015

(57) ABSTRACT

A system can perform a first sentiment-based analysis based on interaction data representative of an interaction between the system and a user profile. The system can perform a second sentiment-based analysis based on publication data representative of a publication associated with the user profile. The system can generate a sentiment-based user profile for the user profile based on respective results of the first sentiment-based analysis and the second sentiment-based analysis. The system can input the sentiment-based user profile and impact data representative of an impact that the user profile has on an entity associated with the system to a trained artificial intelligence model, to produce an output that indicates a proposed action to take with respect to the user profile. The system can store an indication of the output.

### BACKGROUND

A sentiment of a user in an interaction can be evaluated.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can perform a first sentiment-based analysis based on interaction data representative of an interaction between the system and a user profile. The system can perform a second sentiment-based analysis based on publication data representative of a publication associated with the user profile. The system can generate a sentiment-based user profile for the user profile based on respective results of the first sentiment-based analysis and the second sentiment-based analysis. The system can input the sentiment-based user profile and impact data representative of an impact that the user profile has on an entity associated with the system to a trained artificial intelligence model, to produce an output that indicates a proposed action to take with respect to the user profile. The system can store an indication of the output.

An example method can comprise performing, by a system comprising at least one processor, a first sentiment-based analysis with respect to an interaction between the system and a user profile. The system can further comprise performing, by the system, a second sentiment-based analysis with respect to a publication associated with the user profile. The system can further comprise generating, by the system, a sentiment-based user profile for the user profile based on the first sentiment-based analysis and the second sentiment-based analysis. The system can further comprise providing, by the system as input to a trained artificial intelligence model, the sentiment-based user profile and an impact that the user profile is determined to have on an entity associated with the system, to produce an output, from the trained artificial intelligence model, that indicates a proposed action to take with respect to the user profile.

An example non-transitory computer-readable medium can comprise instructions that, in response to execution, cause a system comprising a processor to perform operations. These operations can comprise generating a sentiment-based user profile for a user profile based on a first sentiment-based analysis on an interaction between the system and the user profile, and a second sentiment-based analysis on a publication associated with the user profile. These operations can further comprise inputting the sentiment-based user profile and an impact that the user profile has on an entity associated with the system to a trained artificial intelligence model, resulting in an output from the trained artificial intelligence model that indicates a proposed action to take with respect to the user profile.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate user profile sentiment analysis, in accordance with an embodiment of this disclosure;

FIG. 2 illustrates another example system architecture that can facilitate user profile sentiment analysis, in accordance with an embodiment of this disclosure;

FIG. 3 illustrates another example system architecture that can facilitate user profile sentiment analysis, in accordance with an embodiment of this disclosure;

FIG. 4 illustrates another example process flow that can facilitate user profile sentiment analysis, in accordance with an embodiment of this disclosure;

FIG. 5 illustrates another example process flow that can facilitate user profile sentiment analysis, in accordance with an embodiment of this disclosure;

FIG. 6 illustrates another example process flow that can facilitate user profile sentiment analysis, in accordance with an embodiment of this disclosure;

FIG. 7 illustrates another example process flow that can facilitate user profile sentiment analysis, in accordance with an embodiment of this disclosure;

FIG. 8 illustrates another example process flow that can facilitate user profile sentiment analysis, in accordance with an embodiment of this disclosure;

FIG. 9 illustrates another example process flow that can facilitate user profile sentiment analysis, in accordance with an embodiment of this disclosure;

FIG. 10 illustrates an example block diagram of a computer operable to execute an embodiment of this disclosure.

### DETAILED DESCRIPTION

### Overview

In a user-centric landscape, where artificial intelligence (AI)-powered tools can engage directly with users, understanding users' nuances and preferences can be crucial for effective communication and relationship-building.

However, existing approaches for assessing user satisfaction, expression patterns, and retention risks can lack granularity sufficient to optimize these interactions.

Moreover, with the rise of AI-driven conversations, the ability to personalize and tailor these interactions can become increasingly vital.

Despite the wealth of available user data, entities (e.g., businesses) can struggle to extract actionable insights to inform these interactions effectively.

Thus, there can be a need for a streamlined approach to analyze user data comprehensively and predict their behavior accurately, enabling AI tools to engage in more personalized and effective conversations.

This present techniques can address these challenges with prior approaches by introducing a sophisticated system that leverages existing data and characteristics to provide nuanced insights into user behavior, empowering businesses to enhance their AI-driven interactions and elevate the overall user experience.

Additionally, the present techniques can leverage and enhance techniques of determining a user's sentiment from external publications on social media (e.g., historical-engagements and/or real-time ones).

It can be that a user's sentiment in a “work-place” environment might be very different from a “non-work-place” environment.

These missing factors can be taken into account and leveraged to build a full sentiment profile and score of each user.

Organizations can streamline their support processes and enhance overall satisfaction by implementing clear guidelines, leveraging technology, and fostering a user-centric culture alongside elevating user satisfaction, in accordance with the present techniques.

The present techniques can be implemented to facilitate a sentiment-based enhanced solution to build a user's full sentiment profile and score, where non-work-environments can be taken into account, as well (e.g., social media).

This can be performed by providing additional insights and leveraging the user's emotional state by adding the above-mentioned context.

As a process according to the present techniques can be automated, it can be that it is not subject to the same challenges as a subjective user's representative decision is.

The present techniques can integrate sentiment scores derived from sentiment analysis of user communication inputs (e.g., user interactions with an entity that facilitates the present techniques, and user-public interactions—e.g., negatively publishing on social media).

For instance, cases with high technical severity and negative sentiment can be prioritized over those with similar severity but neutral or positive sentiment. This can ensure that emotionally-charged issues are addressed promptly, even if their technical severity alone might not warrant immediate attention.

Consider the following examples. In a first example, a support representative of the entity, a new employee, is on a chat/call with user X. The support agent is quite new so he/she might be slow. From the work-environment sentiment-analysis, user X seems to be engaged in a natural way, whereas he/she is publishing a very negative experience on his/her social media platforms (non-work-environment) regarding working with the entity. With the present techniques, this non-work activity can be taken into account, as well.

In a second example, an entity's support representative is on a chat/call with user Y. Pre-engaging with user Y, the agent had received a full non-work-environment sentiment-analysis profile on user Y only to reveal that user Y seldom publishes negative sentiment regarding the entity's support.

This enhanced addition can put the agent in a “be sensitive” mindset, and where the agent can try to elevate user Y's emotional state, before even starting to engage.

In a third example, a support representative, is on a chat/call with user Z, which is a new user to the entity.

In this case, it can be that there are no historical work-environment records, so it can be that work-environment sentiment-analysis is not possible.

In this scenario, a non-work-environment (social-media) sentiment-analysis can be leveraged, both real-time and with previous publications, as well (for instance, if the user's agent interacted with the entity in the past while he or she worked in a different company).

User sentiment analysis according to the present techniques can be leveraged in the following examples:
Real-time social-media publications monitoring (mid-engagement) of user sentiment can help identify sudden spikes in negative sentiment. These can indicate emerging issues or widespread dissatisfaction that prompt immediate attention. Automated escalation mechanisms can trigger alerts or escalate cases based on predefined thresholds of negative sentiment, ensuring timely intervention to address user concerns.
Previous social-media publications monitoring (pre-engagement) of user sentiment can help identify sudden spikes in negative sentiment.
These can indicate emerging issues or widespread dissatisfaction that prompt immediate attention. Automated escalation mechanisms can trigger alerts or escalate cases based on predefined thresholds of negative sentiment, ensuring timely intervention to address user concerns.
Aspect-based sentiment analysis can identify specific aspects or topics in user communications that drive positive or negative sentiment. By linking sentiment to individual aspects or features of products or services, organizations can prioritize cases based on the perceived impact on user satisfaction. For example, a software bug affecting a critical feature can receive higher priority if it generates widespread negative sentiment among users.
Voice data can contain features that can be leveraged for sentiment analysis, such as tone of voice, speech patterns, or vocal cues. Feature engineering techniques can be applied to extract relevant features from audio data, which can be used as input to sentiment analysis models to improve accuracy.

That is, the present techniques can be implemented to better learn a user's emotional state, incorporating a sentiment score.

### Example Architectures

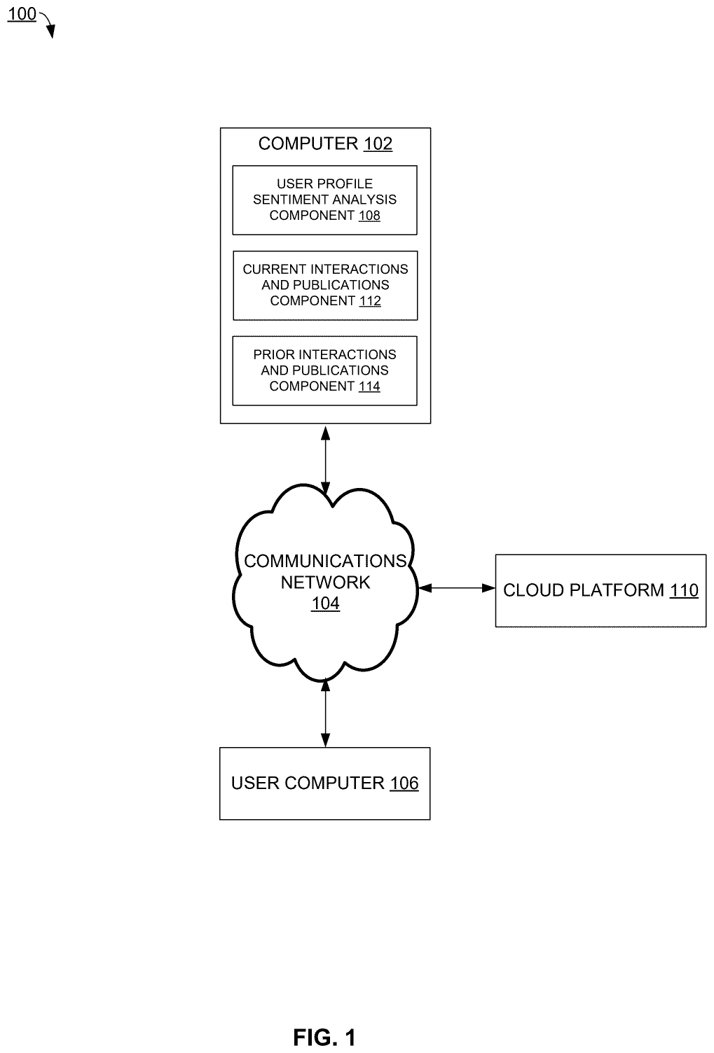

FIG. 1 illustrates an example system architecture 100 that can facilitate user profile sentiment analysis, in accordance with an embodiment of this disclosure.

System architecture 100 comprises computer 102, communications network 104, user computer 106, and cloud platform 110. In turn, computer 102 comprises user profile sentiment analysis component 108, current interactions and publications component 112, and prior interactions and publications component 114.

System architecture 100 presents one logical example of implementing the present techniques, and it can be appreciated that there can be other example architectures.

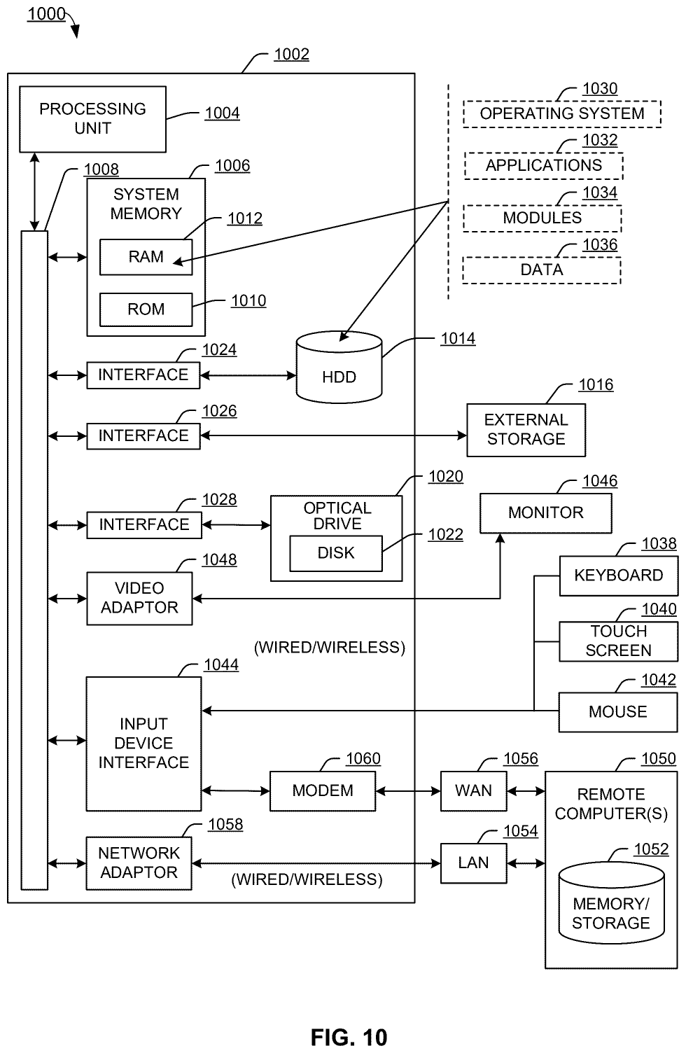

Each of computer 102, user computer 106, and/or cloud platform 110 can be implemented with part(s) of computing environment 1000 of FIG. 10. Communications network 104 can comprise a computer communications network, such as the Internet, or an intranet.

When a user account (e.g., one associated with user computer 106) contacts computer 102, computer 102 can perform sentiment analysis on the user account. Current interactions and publications component 112 can analyze the user account's sentiment of the current interaction and/or publications that the user account is making during the current interaction. Prior interactions and publications component 114 can analyze the user account's sentiment from interaction and/or publications that the user account made prior to the current interaction.

User profile sentiment analysis component 108 can use the sentiment analysis from current interactions and publications component 112 and prior interactions and publications component 114 to determine an overall sentiment associated with the user account, and from that determine an output (e.g., to escalate an issue associated with the user account, or a response to provide to the user account).

In some examples, some or all of the operations described as being performed by computer 102 can be performed by cloud platform 110.

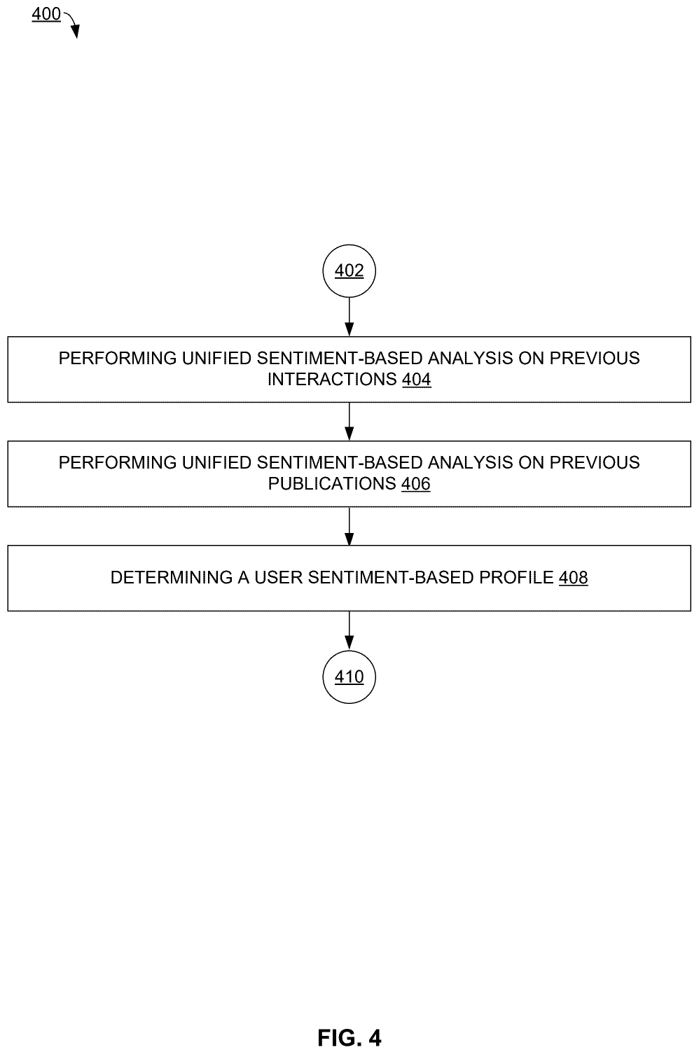

In some examples, user profile sentiment analysis component 108 can implement part(s) of the process flows of FIGS. 4-9 to implement user profile sentiment analysis.

It can be appreciated that system architecture 100 is one example system architecture for user profile sentiment analysis, and that there can be other system architectures that facilitate user profile sentiment analysis.

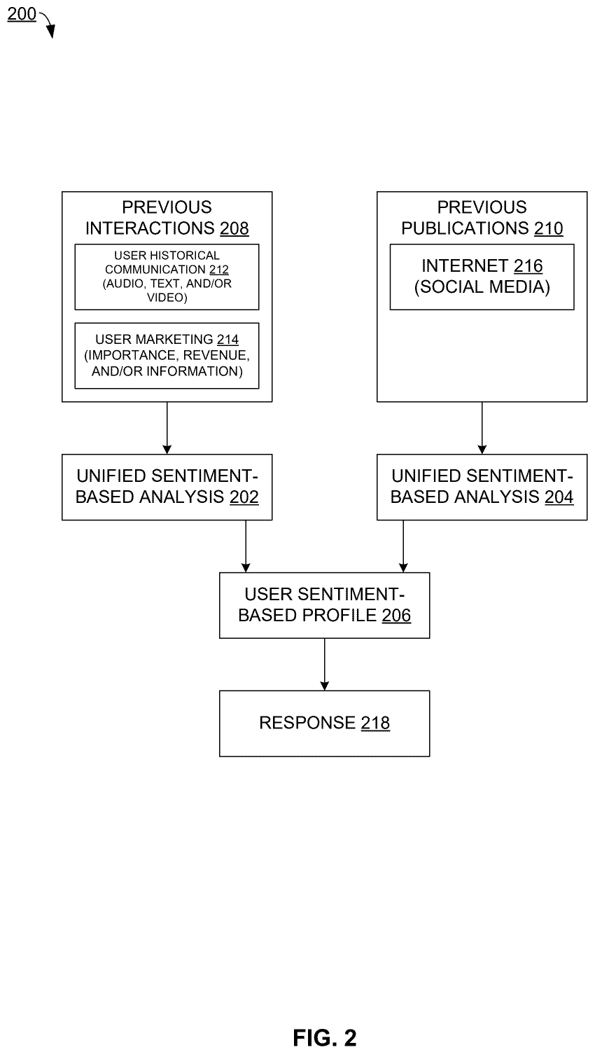

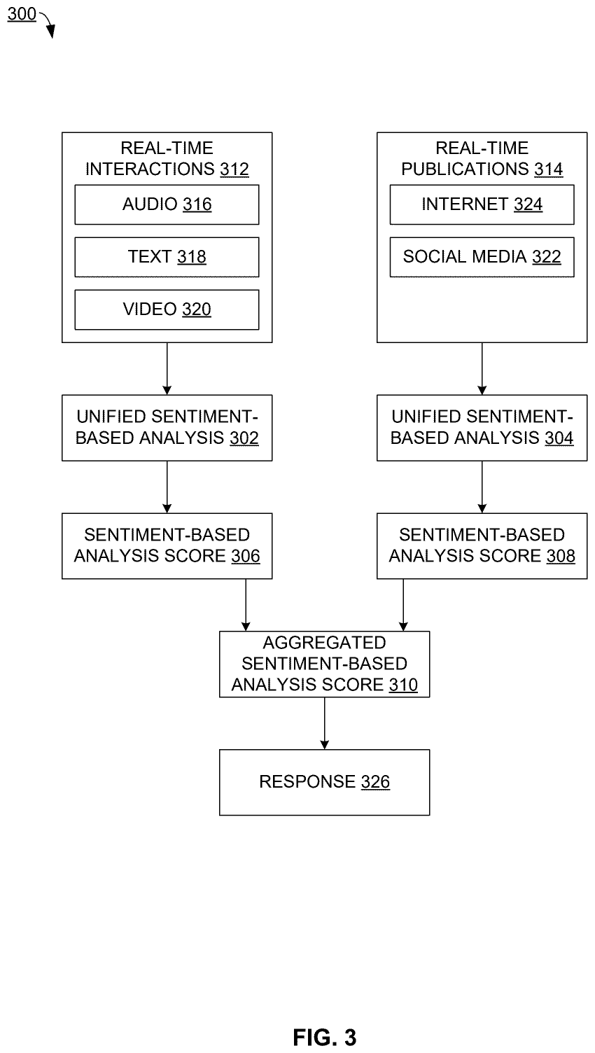

FIG. 2 illustrates another example system architecture 200 that can facilitate user profile sentiment analysis, in accordance with an embodiment of this disclosure. In some examples, part(s) of system architecture 200 can be implemented by part(s) of system architecture 100 of FIG. 1 to facilitate user profile sentiment analysis. In some examples, part(s) of system architecture 200 can be implemented in conjunction with part(s) of system architecture 300 of FIG. 3 to facilitate user profile sentiment analysis.

System architecture 200 comprises unified sentiment-based analysis 202, unified sentiment-based analysis 204, user sentiment-based profile 206, previous interactions 208, previous publications 210, user historical communication 212, user marketing 214, internet 216, and response 218.

User historical communication 212 can comprise audio, text, and/or video. User marketing 214 can comprise importance, revenue, and/or information. Internet 216 can comprise Internet-based publications such as social media.

FIG. 3 illustrates another example system architecture 300 that can facilitate user profile sentiment analysis, in accordance with an embodiment of this disclosure. In some examples, part(s) of system architecture 300 can be implemented by part(s) of system architecture 100 of FIG. 1 to facilitate user profile sentiment analysis. In some examples, part(s) of system architecture 300 can be implemented in conjunction with part(s) of system architecture 200 of FIG. 2 to facilitate user profile sentiment analysis.

System architecture 300 comprises unified sentiment-based analysis 302, unified sentiment-based analysis 304, sentiment-based analysis score 306, sentiment-based analysis score 308, aggregated sentiment-based analysis score 310, real-time interactions 312, real-time publications 314, audio 316, text 318, video 320, social media 322, internet 324, and response 326.

### Example Process Flows

FIG. 4 illustrates an example process flow 400 that can facilitate user profile sentiment analysis, in accordance with an embodiment of this disclosure. In some examples, one or more embodiments of process flow 400 can be implemented by user profile sentiment analysis component 108 of FIG. 1, or computing environment 1000 of FIG. 10.

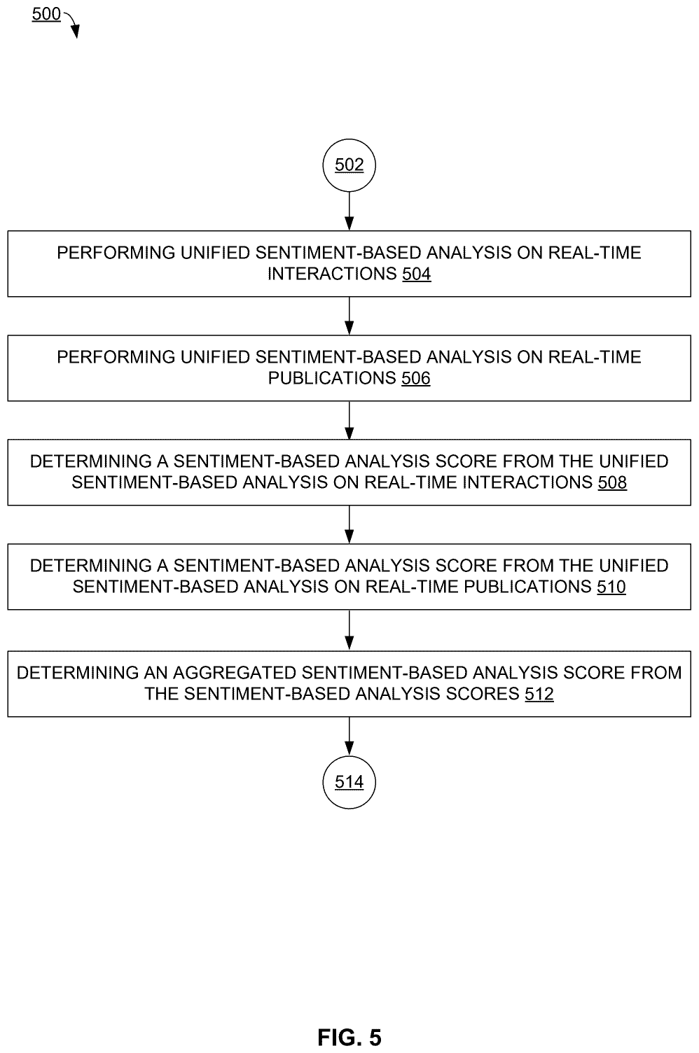

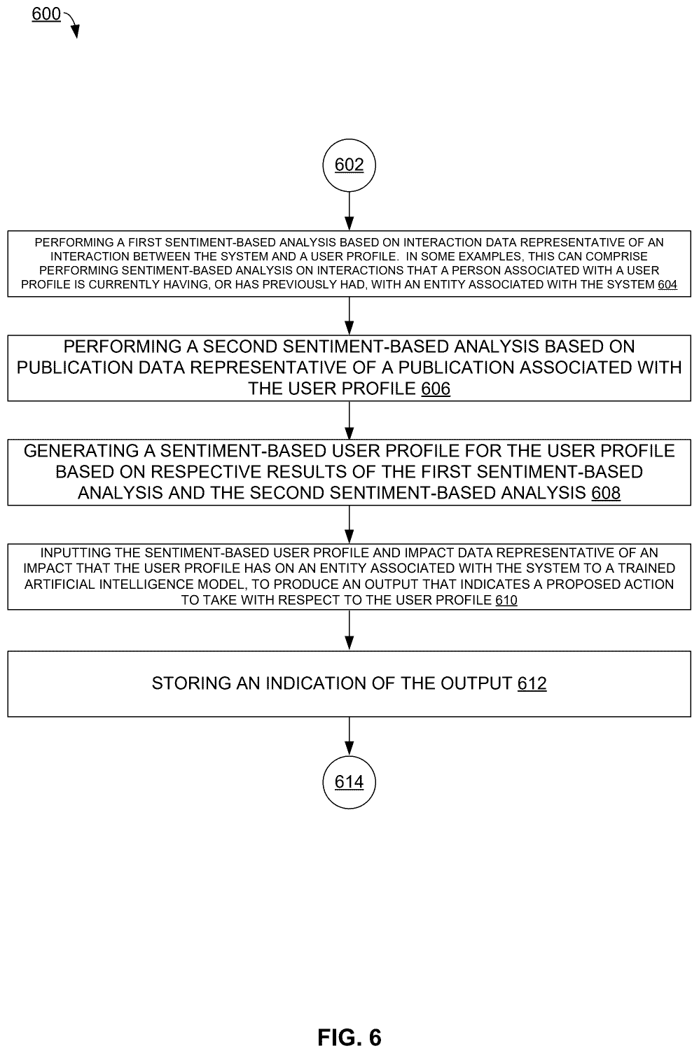

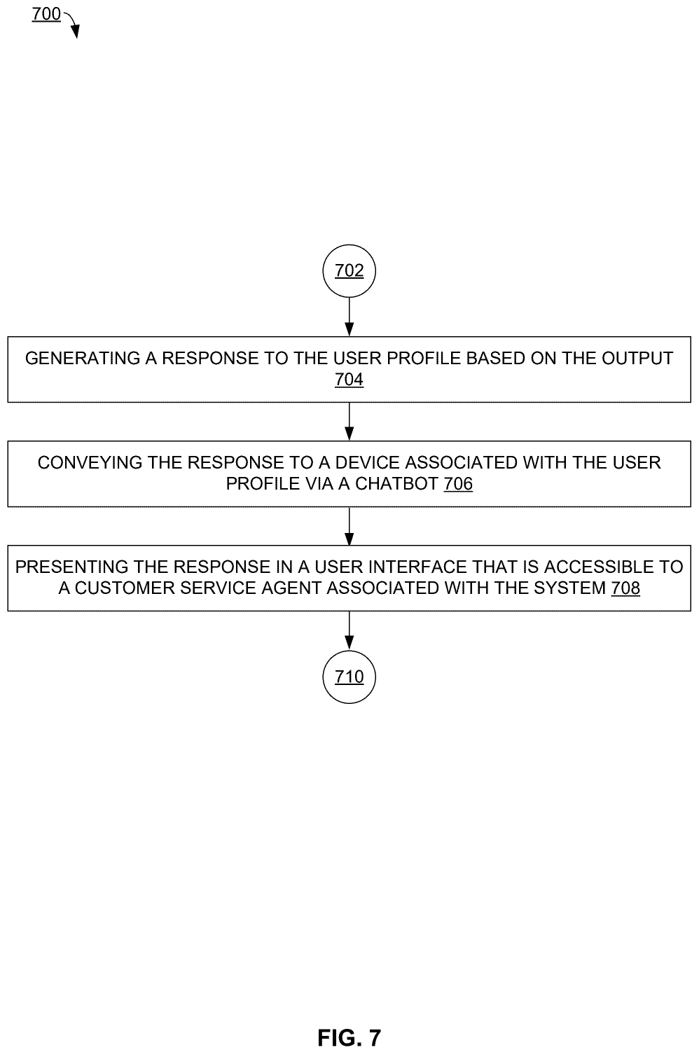

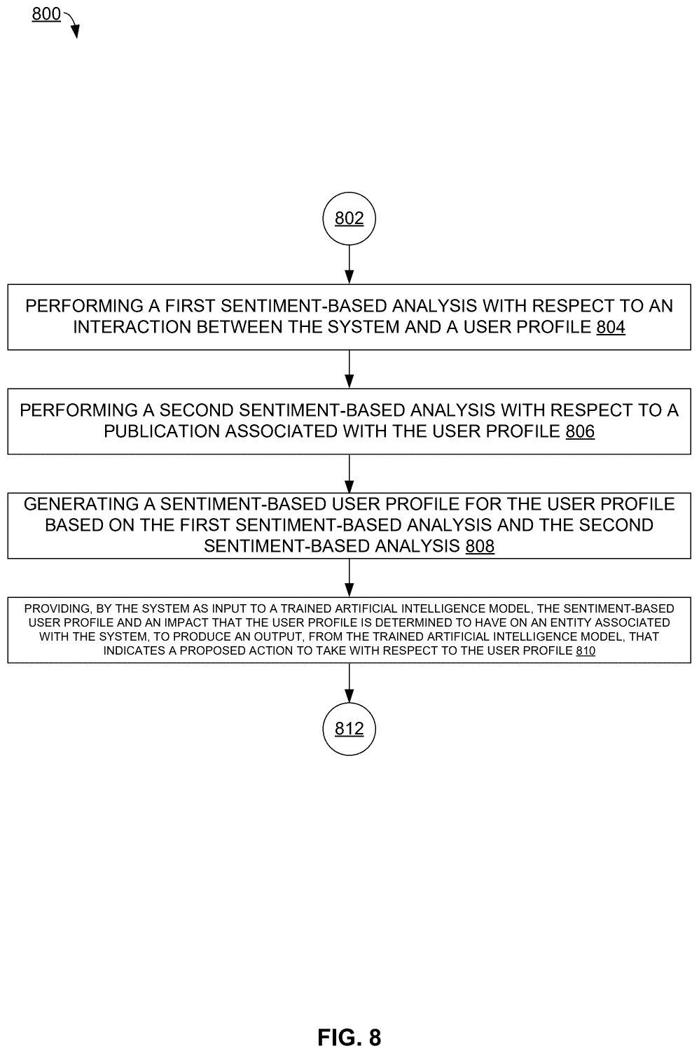

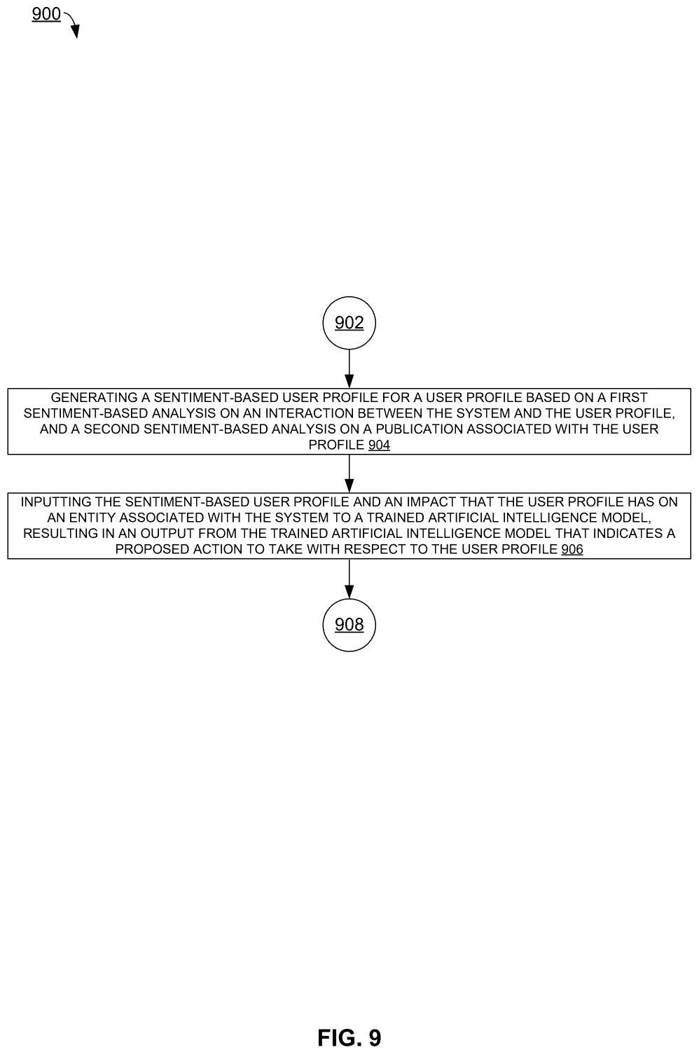

It can be appreciated that the operating procedures of process flow 400 are example operating procedures, and that there can be embodiments that implement more or fewer operating procedures than are depicted, or that implement the depicted operating procedures in a different order than as depicted. In some examples, process flow 400 can be implemented in conjunction with one or more embodiments of one or more of process flow 500 of FIG. 5, process flow 600 of FIG. 6, process flow 700 of FIG. 7, process flow 800 of FIG. 8, and/or process flow 900 or FIG. 9.

Process flow 400 begins with 402, and moves to operation 404.

Operation 404 depicts performing unified sentiment-based analysis on previous interactions. This can be performed in a manner similar to unified sentiment-based analysis 202 of FIG. 2.

After operation 404, process flow 400 moves to operation 406.

Operation 406 depicts performing unified sentiment-based analysis on previous publications. This can be performed in a manner similar to unified sentiment-based analysis 204 of FIG. 2.

After operation 406, process flow 400 moves to operation 408.

Operation 408 depicts determining a user sentiment-based profile. This can be performed in a manner similar to user sentiment-based profile 206 of FIG. 2.

After operation 408, process flow 400 moves to 410, where process flow 400 ends.

FIG. 5 illustrates an example process flow 500 that can facilitate user profile sentiment analysis, in accordance with an embodiment of this disclosure. In some examples, one or more embodiments of process flow 500 can be implemented by user profile sentiment analysis component 108 of FIG. 1, or computing environment 1000 of FIG. 10.

It can be appreciated that the operating procedures of process flow 500 are example operating procedures, and that there can be embodiments that implement more or fewer operating procedures than are depicted, or that implement the depicted operating procedures in a different order than as depicted. In some examples, process flow 500 can be implemented in conjunction with one or more embodiments of one or more of process flow 400 of FIG. 4, process flow 600 of FIG. 6, process flow 700 of FIG. 7, process flow 800 of FIG. 8, and/or process flow 900 or FIG. 9.

Process flow 500 begins with 502, and moves to operation 504.

Operation 504 depicts performing unified sentiment-based analysis on real-time interactions. This can be performed in a manner similar to unified sentiment-based analysis 302 of FIG. 3.

After operation 504, process flow 500 moves to operation 506.

Operation 506 depicts performing unified sentiment-based analysis on real-time publications. This can be performed in a manner similar to unified sentiment-based analysis 304 of FIG. 3.

After operation 506, process flow 500 moves to operation 508.

Operation 508 depicts determining a sentiment-based analysis score from the unified sentiment-based analysis on real-time interactions. This can be performed in a manner similar to sentiment-based analysis score 306 of FIG. 3.

After operation 508, process flow 500 moves to operation 510.

Operation 510 depicts determining a sentiment-based analysis score from the unified sentiment-based analysis on real-time publications. This can be performed in a manner similar to sentiment-based analysis score 308 of FIG. 3.

After operation 510, process flow 500 moves to operation 512.

Operation 512 depicts determining an aggregated sentiment-based analysis score from the sentiment-based analysis scores. This can be performed in a manner similar to aggregated sentiment-based analysis score 310 of FIG. 3.

After operation 512, process flow 500 moves to 514, where process flow 500 ends.

FIG. 6 illustrates an example process flow 600 that can facilitate user profile sentiment analysis, in accordance with an embodiment of this disclosure. In some examples, one or more embodiments of process flow 600 can be implemented by user profile sentiment analysis component 108 of FIG. 1, or computing environment 1000 of FIG. 10.

It can be appreciated that the operating procedures of process flow 600 are example operating procedures, and that there can be embodiments that implement more or fewer operating procedures than are depicted, or that implement the depicted operating procedures in a different order than as depicted. In some examples, process flow 600 can be implemented in conjunction with one or more embodiments of one or more of process flow 400 of FIG. 4, process flow 500 of FIG. 5, process flow 700 of FIG. 7, process flow 800 of FIG. 8, and/or process flow 900 or FIG. 9.

Process flow 600 begins with 602, and moves to operation 604.

Operation 604 depicts performing a first sentiment-based analysis based on interaction data representative of an interaction between the system and a user profile. In some examples, this can comprise performing sentiment-based analysis on interactions that a person associated with a user profile is currently having, or has previously had, with an entity associated with the system.

In some examples, the interaction is a previous interaction relative to a current interaction with the user profile, and the publication is a previous publication relative to the current interaction. That is, there can be a pre-engagement scenario.

In some examples, the performing of the first sentiment-based analysis is in response to the interaction occurring, or the performing of the second sentiment-based analysis is in response to the publication occurring. That is, there can be a mid-engagement scenario.

After operation 604, process flow 800 moves to operation 606.

Operation 606 depicts performing a second sentiment-based analysis based on publication data representative of a publication associated with the user profile. In some examples, this can comprise performing sentiment-based analysis on publications that a person associated with a user profile is currently making (during an interaction with an entity associated with the system), or has previously made.

After operation 606, process flow 800 moves to operation 608.

Operation 608 depicts generating a sentiment-based user profile for the user profile based on respective results of the first sentiment-based analysis and the second sentiment-based analysis. In some examples, this can comprise creating a customer sentiment-based profile from the sentiment-based analyses of operations 604-606.

After operation 608, process flow 800 moves to operation 610.

Operation 610 depicts inputting the sentiment-based user profile and impact data representative of an impact that the user profile has on an entity associated with the system to a trained artificial intelligence model, to produce an output that indicates a proposed action to take with respect to the user profile. The result of operation 608 can be used as input to an AI model along with an impact that the user account can have on the entity's brand reputation.

In some examples, the system performs the performing of the first sentiment-based analysis, the performing of the second sentiment-based analysis, the generating, and the inputting using cloud computing service of a cloud computing platform. That is, processing aspects of the present techniques can be performed in the cloud.

After operation 610, process flow 800 moves to operation 612.

Operation 612 depicts storing an indication of the output. This output can be used, for example, to escalate an issue, to raise an alert, to provide a proposed response to a customer service agent, or to provide a response to the user account via a chatbot.

After operation 612, process flow 800 moves to 614, where process flow 600 ends.

FIG. 7 illustrates an example process flow 700 that can facilitate user profile sentiment analysis, in accordance with an embodiment of this disclosure. In some examples, one or more embodiments of process flow 700 can be implemented by user profile sentiment analysis component 108 of FIG. 1, or computing environment 1000 of FIG. 10.

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 700 can be implemented in conjunction with one or more embodiments of one or more of process flow 400 of FIG. 4, process flow 500 of FIG. 5, process flow 700 of FIG. 7, process flow 800 of FIG. 8, and/or process flow 900 or FIG. 9.

Process flow 700 begins with 702, and moves to operation 704.

Operation 704 depicts generating a response to the user profile based on the output. This response can relate to a question or statement associated with the user profile, or for an issue (e.g., a problem with a computer system) associated with the user profile.

After operation 704, process flow 700 moves to operation 706 and/or operation 708.

Operation 706 depicts conveying the response to a device associated with the user profile via a chatbot. That is, a chatbot can convey the response to a user.

After operation 706, process flow 700 moves to 710, where process flow 700 ends.

Operation 708 depicts presenting the response in a user interface that is accessible to a customer service agent associated with the system. That is, a customer service agent can be presented with the proposed response, and can choose to say or message it to a user.

After operation 708, process flow 700 moves to 710, where process flow 700 ends.

FIG. 8 illustrates an example process flow 800 that can facilitate user profile sentiment analysis, in accordance with an embodiment of this disclosure. In some examples, one or more embodiments of process flow 800 can be implemented by user profile sentiment analysis component 108 of FIG. 1, or computing environment 1000 of FIG. 10.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of one or more of process flow 400 of FIG. 4, process flow 500 of FIG. 5, process flow 800 of FIG. 8, process flow 800 of FIG. 8, and/or process flow 900 or FIG. 9.

Process flow 800 begins with 802, and moves to operation 804.

Operation 804 depicts performing a first sentiment-based analysis with respect to an interaction between the system and a user profile. In some examples, operation 804 can be implemented in a similar manner as operation 604 of FIG. 6.

In some examples, the interaction comprises at least one of an audio interaction, a text interaction, or a video interaction.

In some examples, the interaction comprises a voice interaction involving at least one voice, and wherein the first sentiment-based analysis is performed based on at least one tone of the at least one voice of the voice interaction, at least one speech pattern of the at least one voice of the voice interaction, or at least one vocal cue of the at least one voice of the voice interaction. That is, it can be that voice data contains features that can be leveraged for sentiment analysis, such as tone of voice, speech patterns, or vocal cues.

In some examples, operation 804 comprises performing feature engineering on the at least one voice of the voice interaction to extract features of the voice interaction, resulting in extracted features, and providing the extracted features of the voice interaction as input to a sentiment analysis model that performs the first sentiment-based analysis. That is, feature engineering can be applied to extract relevant features from audio data, which can be used as input to sentiment analysis models to improve frequency.

In some examples, the interaction comprises a marketing interaction with marketing information associated with the user profile. In some examples, the marketing information comprises at least one of importance information representative of an importance of the user profile to the entity, money information representative of an amount of money associated with the user profile that is paid to the entity, or user profile information about the user profile.

After operation 804, process flow 800 moves to operation 806.

Operation 806 depicts performing a second sentiment-based analysis with respect to a publication associated with the user profile. In some examples, operation 806 can be implemented in a similar manner as operation 606 of FIG. 6.

In some examples, the publication comprises a social media posting associated with the user profile.

After operation 806, process flow 800 moves to operation 808.

Operation 808 depicts generating a sentiment-based user profile for the user profile based on the first sentiment-based analysis and the second sentiment-based analysis. In some examples, operation 808 can be implemented in a similar manner as operation 608 of FIG. 6.

After operation 808, process flow 800 moves to operation 810.

Operation 810 depicts providing, by the system as input to a trained artificial intelligence model, the sentiment-based user profile and an impact that the user profile is determined to have on an entity associated with the system, to produce an output, from the trained artificial intelligence model, that indicates a proposed action to take with respect to the user profile. In some examples, operation 810 can be implemented in a similar manner as operation 610 of FIG. 6.

After operation 810, process flow 800 moves to 812, where process flow 800 ends.

FIG. 9 illustrates an example process flow 900 that can facilitate user profile sentiment analysis, in accordance with an embodiment of this disclosure. In some examples, one or more embodiments of process flow 900 can be implemented by user profile sentiment analysis component 108 of FIG. 1, or computing environment 1000 of FIG. 10.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of one or more of process flow 400 of FIG. 4, process flow 500 of FIG. 5, process flow 900 of FIG. 9, process flow 900 of FIG. 9, and/or process flow 900 or FIG. 9.

Process flow 900 begins with 902, and moves to operation 904.

Operation 904 depicts generating a sentiment-based user profile for a user profile based on a first sentiment-based analysis on an interaction between the system and the user profile, and a second sentiment-based analysis on a publication associated with the user profile. In some examples, operation 904 can be implemented in a similar manner as operation 604 of FIG. 6.

After operation 904, process flow 900 moves to operation 906.

Operation 906 depicts inputting the sentiment-based user profile and an impact that the user profile has on an entity associated with the system to a trained artificial intelligence model, resulting in an output from the trained artificial intelligence model that indicates a proposed action to take with respect to the user profile. In some examples, operation 906 can be implemented in a similar manner as operation 606 of FIG. 6.

In some examples, operation 906 comprises, based on the output, triggering an alert. In some examples, operation 906 comprises, based on the output, escalating a case associated with the user profile. In some examples, the escalating of the case is performed based on the trained artificial intelligence model identifying a negative sentiment associated with the user profile that satisfies a negativity criterion. That is, in some examples, escalation mechanisms can trigger alerts or escalate cases based on predefined thresholds of negative sentiment, which can facilitate timely intervention to address customer concerns.

In some examples, the output identifies an aspect of communications that modifies a first metric associated with a positive sentiment associated with the user profile or modifies a second metric associated with a negative sentiment associated with the user profile. In some examples, the output identifies a topic that modifies a first metric associated with a positive sentiment associated with the user profile or modifies a second metric associated with a negative sentiment associated with the user profile. That is, aspect-based sentiment analysis according to the present techniques can identify specific aspects or topics in customer communications that drive positive or negative sentiment. By linking sentiment to individual aspects or features of products or services, organizations can prioritize cases based on the perceived impact on customer satisfaction. For example, a software bug affecting a critical feature can receive higher priority if it generates widespread negative sentiment among customers.

After operation 906, process flow 900 moves to 908, where process flow 900 ends.

### Example Operating Environment

In order to provide additional context for various embodiments described herein, FIG. 10 and the following discussion are intended to provide a brief, general description of a suitable computing environment 1000 in which the various embodiments of the embodiment described herein can be implemented.

For example, parts of computing environment 1000 can be used to implement one or more embodiments of computer 102, user computer 106, and/or cloud platform 110.

In some examples, computing environment 1000 can implement one or more embodiments of the process flows of FIGS. 4-9 to facilitate user profile sentiment analysis.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a nonvolatile storage such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are examples, and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
performing a first sentiment-based analysis based on interaction data representative of an interaction between the system and a user profile;
performing a second sentiment-based analysis based on publication data representative of a publication associated with the user profile;
generating a sentiment-based user profile for the user profile based on respective results of the first sentiment-based analysis and the second sentiment-based analysis;
inputting the sentiment-based user profile and impact data representative of an impact that the user profile has on an entity associated with the system to a trained artificial intelligence model, to produce an output that indicates a proposed action to take with respect to the user profile; and
storing an indication of the output.

2. The system of claim 1, wherein the system performs the performing of the first sentiment-based analysis, the performing of the second sentiment-based analysis, the generating, and the inputting using cloud computing service of a cloud computing platform.

3. The system of claim 1, wherein the operations further comprise:
generating a response to the user profile based on the output.

4. The system of claim 3, wherein the operations further comprise:
conveying the response to a device associated with the user profile via a chatbot.

5. The system of claim 3, wherein the operations further comprise:
presenting the response in a user interface that is accessible to a customer service agent associated with the system.

6. The system of claim 1, wherein the interaction is a previous interaction relative to a current interaction with the user profile, and wherein the publication is a previous publication relative to the current interaction.

7. The system of claim 1, wherein the performing of the first sentiment-based analysis is in response to the interaction occurring, or wherein the performing of the second sentiment-based analysis is in response to the publication occurring.

8. A method, comprising:
performing, by a system comprising at least one processor, a first sentiment-based analysis with respect to an interaction between the system and a user profile;
performing, by the system, a second sentiment-based analysis with respect to a publication associated with the user profile;
generating, by the system, a sentiment-based user profile for the user profile based on the first sentiment-based analysis and the second sentiment-based analysis; and
providing, by the system as input to a trained artificial intelligence model, the sentiment-based user profile and an impact that the user profile is determined to have on an entity associated with the system, to produce an output, from the trained artificial intelligence model, that indicates a proposed action to take with respect to the user profile.

9. The method of claim 8, wherein the interaction comprises at least one of an audio interaction, a text interaction, or a video interaction.

10. The method of claim 8, wherein the interaction comprises a voice interaction involving at least one voice, and wherein the first sentiment-based analysis is performed based on at least one tone of the at least one voice of the voice interaction, at least one speech pattern of the at least one voice of the voice interaction, or at least one vocal cue of the at least one voice of the voice interaction.

11. The method of claim 10, further comprising:
performing, by the system, feature engineering on the at least one voice of the voice interaction to extract features of the voice interaction, resulting in extracted features; and
providing, by the system, the extracted features of the voice interaction as input to a sentiment analysis model that performs the first sentiment-based analysis.

12. The method of claim 8, wherein the interaction comprises a marketing interaction with marketing information associated with the user profile.

13. The method of claim 12, wherein the marketing information comprises at least one of importance information representative of an importance of the user profile to the entity, money information representative of an amount of money associated with the user profile that is paid to the entity, or user profile information about the user profile.

14. The method of claim 8, wherein the publication comprises a social media posting associated with the user profile.

15. A non-transitory computer-readable medium comprising instructions that, in response to execution, cause a system comprising at least one processor to perform operations, comprising:
generating a sentiment-based user profile for a user profile based on a first sentiment-based analysis on an interaction between the system and the user profile, and a second sentiment-based analysis on a publication associated with the user profile; and
inputting the sentiment-based user profile and an impact that the user profile has on an entity associated with the system to a trained artificial intelligence model, resulting in an output from the trained artificial intelligence model that indicates a proposed action to take with respect to the user profile.

16. The non-transitory computer-readable medium of claim 15, wherein the operations further comprise, based on the output, triggering an alert.

17. The non-transitory computer-readable medium of claim 15, wherein the operations further comprise, based on the output, escalating a case associated with the user profile.

18. The non-transitory computer-readable medium of claim 17, wherein the escalating of the case is performed based on the trained artificial intelligence model identifying a negative sentiment associated with the user profile that satisfies a negativity criterion.

19. The non-transitory computer-readable medium of claim 15, wherein the output identifies an aspect of communications that modifies a first metric associated with a positive sentiment associated with the user profile or modifies a second metric associated with a negative sentiment associated with the user profile.

20. The non-transitory computer-readable medium of claim 15, wherein the output identifies a topic that modifies a first metric associated with a positive sentiment associated with the user profile or modifies a second metric associated with a negative sentiment associated with the user profile.
